(19) United States
(12) Patent Application Publication
(10) Pub. No.: US 2014/0165695 A1
(43) Pub. Date: Jun. 19, 2014

(54) Improvised Explosive Device (IED) Test Fixture

(71) Applicant: United States of America as represented by the Secretary of the Navy, (US)

(72) Inventors: DESIRÉE SMITH, LEXINGTON PARK, MD (US); EDWIN SIEVEKA, VALLEY LEE, MD (US); BRANDON HALL, HOLLYWOOD, MD (US)

(73) Assignee: United States of America as represented by the Secretary of the Navy, Patuxent River, MD (US)

(21) Appl. No.: 13/709,179

(22) Filed: Dec. 10, 2012

(51) Int. Cl. G01N 3/60; G01N 3/30

(52) U.S. Cl. CPC G01N 3/60; G01N 3/30
USPC 73/12.09

(57) ABSTRACT

An explosive device test fixture which includes a horizontal accelerator having a track, a main sled, and a mini-sled. The main sled is able to be travel on the track, and has main sled rails. The mini-sled is smaller than the main sled such that the mini-sled can travel along the main sled rails. When the horizontal accelerator is actuated it fires a pulse. The pulse causes the main sled to travel along the track, while the mini-sled remains stationary causing the main sled to hit the mini-sled and simulate acceleration forces on the mini-sled similar to acceleration forces in an actual explosion.

### STATEMENT OF GOVERNMENT INTEREST

The invention described herein may be manufactured and used by or for the Government of the United States of America for governmental purposes without payment of any royalties thereon or therefor.

### BACKGROUND

Ground vehicle passengers are sometimes subject to blast pulses from explosion devices buried in the ground or at ground level. Since they are often seated during missions, the seats must be designed to withstand or minimize the impact of these blasts. The seats must be tested for blast resistance. To date the only method used to simulate a blast pulse, for blast resistant seat testing, is to conduct drop testing. This testing consists of lifting a seat to a predetermined height. Once the seat reaches the required height, the seat and supporting test structure is dropped.

There are a number of limitations using this method. As the severity of the explosive devices increase, due to increased amounts of propellant or the use of more reactive explosives, the blast pulse is increased, and thus the height must be increased. The drop height, and therefore simulated pulse, is limited to the height of the drop tower. The majority of drop towers are located outside; therefore, heir use is limited by weather conditions. When using a drop tower, the fall imparts a no load case on the seat due to free fall. Additionally, the effects of free fall must be accounted when determining the effectiveness of the seat.

Therefore, there is a need for an explosive device test fixture that can simulate a test blast upon a seat or other piece of equipment.

### SUMMARY

The present invention is directed to an explosive device test fixture that meets the needs enumerated above and below.

The present invention is directed to an explosive device test fixture which includes a horizontal accelerator having a track, a main sled, and a mini-sled. The main sled is able to be travel on the track, and has main sled rails. The mini-sled is smaller than the main sled such that the mini-sled can travel along the main sled rails. When the horizontal accelerator is actuated it fires a pulse. The pulse causes the main sled to travel along the track, while the mini-sled remains stationary causing the main sled to hit the mini-sled and simulate acceleration forces on the mini-sled similar to acceleration forces in an actual explosion

It is a feature of the present invention to provide an explosive device test fixture that, unlike currently used drop testing, there are no free fall effects that need to be accounted for.

It is a feature of the present invention to provide an explosive device test fixture that can accurately simulate the majority of all blast events currently seen in theatre, and any potential different types of blast events.

It is a feature of the present invention to provide an explosive device test fixture that can be quickly configured to accept one or two seats.

It is a feature of the present invention to provide an explosive device test fixture that can be utilized for different seat designs.

It is a feature of the present invention to provide an explosive device test fixture that is not limited by height, other size restraints, or weather considerations.

### DRAWINGS

These and other features, aspects and advantages of the present invention will become better understood with reference to the following description and appended claims, and accompanying drawings wherein:

FIG. 1 is a perspective view of an embodiment of the explosive device test fixture; and,

FIG. 2 is a side view of an embodiment of the explosive device test fixture.

### DESCRIPTION

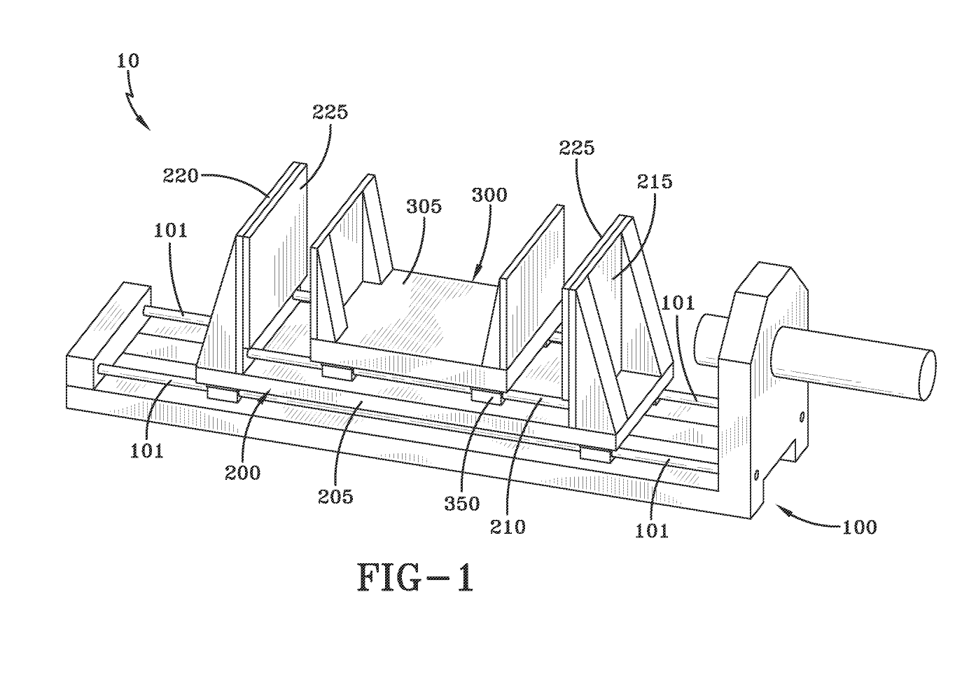

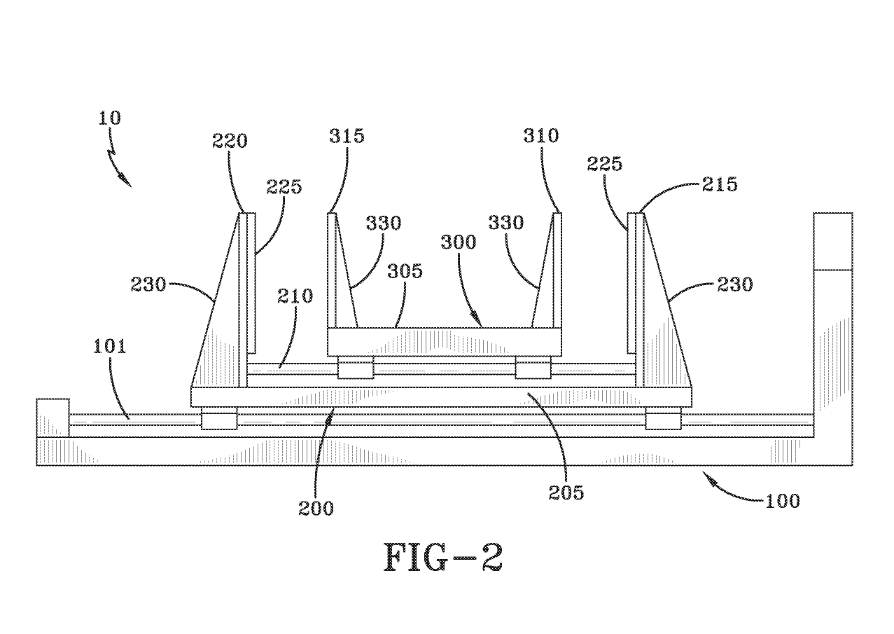

The preferred embodiments of the present invention are illustrated by way of example below and in FIGS. 1 and 2. As shown in FIGS. 1 and 2, an explosive device test fixture 10 includes a horizontal accelerator 100 having a track 101, a main sled 200, and a mini-sled 300. The main sled 200 is able to be travel on the track 101, and has a main sled base plate 205 main sled rails 210, a main sled first contact plate 215, a main sled second contact plate 220, and elastomeric material 225. The main sled rails 210 are disposed on the main sled base plate 205 and are substantially parallel to the track 101. The main sled first contact plate 215 and the main sled second contact plate 220 are vertically disposed on opposite ends of the main sled base plate 205 and substantially perpendicular to the main sled rails 210. The elastomeric material 225 is attached to the main sled first contact plate 215 and the chain sled second contact plate 220. The mini-sled 300 is smaller than the main sled 200 such that the mini-sled 300 can travel along the main sled rails 210. The mini-sled 300 includes a mini-sled base plate 305, a mini-sled first contact plate 310, and a mini-sled second contact plate 315. The mini-sled first contact plate 310 and the mini-sled second contact plate 315 are vertically disposed on opposite ends of the mini-sled base plate 305 and substantially perpendicular to the main sled rails 210. When the horizontal accelerator 100 is actuated it fires a pulse that is shaped by the elastomeric material 225 attached to the min sled first contact plate 215. The pulse causes the main sled 200 to travel along the track 101, while the mini-sled 300 remains stationary causing the main sled first contact plate 215 to hit the mini-sled first contact plate 310 and simulate acceleration forces on the mini-sled 300 similar to acceleration forces in an actual explosion. In operation, a seat that is to be tested is secured in the mini-sled 300 and data is collected.

In the description of the present invention, the invention will be discussed in a military environment; however, this invention can be utilized for any type of application that requires use of a explosive device test fixture.

A horizontal accelerator 100 may be defined, but without limitation, as an apparatus that can make an object move along a track at various speeds and can be used to create acceleration forces and pulse shapes typically seen in crashes and other types of accelerated environments. The horizontal accelerator 100 includes a track 101 (which includes two substantially parallel rails) and a hydraulically controlled linear actuator to move and/or accelerate the objects along the track. The preferred horizontal accelerator 300 operates at a 50 G maximum acceleration, with a 5,000 pound maximum payload at 20 G's.

The mini-sled 300 further includes sliders 350, the sliders 350 are slidably attached to the mini-sled 300 and the main sled rails 210 such that the mini-sled 300 will stay attached to the main sled rails 210 and still slide along the main sled rails 210.

The main sled 200 may further includes main sled supports 230. In the preferred embodiment, the main sled supports are triangularly shaped, However, they may he beams or any other type of support practicable. In the preferred embodiment, as shown in FIGS. 1 and 2, two main sled supports 230 are attached to the main sled base plate 205 and the first main sled contact plate 215, while another two main sled supports 230 are attached to the main sled base plate 205 and the second main sled contact plate 220. The mini-sled 300 may also include mini-sled supports 330. Two mini-sled supports 330 may be attached to the nu sled base plate 305 and the first mini-sled contact plate 310, while another two mini-sled supports 330 are attached to the mini-sled base plate 305 and the second mini-sled contact plate 315. All the mini-sled supports 330 are directed inward and toward from each other and the mini-sled base plate 305 such that the first main sled contact plate 215 and the first mini-sled contact plate 310 are able contact each other, and the second main sled contact plate 220 and the second mini-sled contact plate 315 are able contact each other.

In the preferred embodiment, first mini-sled contact plate 310 may be communicating with an accelerometer, which is communicating with an A/D board and a computer that analyzes the acceleration on the first mini-sled contact plate 310. Data can be collected utilizing a computer driven Data Acquisition System with sensors placed on the seat to be tested, or on any of the contact plates, or anywhere else desired.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed:

1. An explosive device test fixture comprising:
a horizontal accelerator having a track;
a main sled able to be travel on the track, the main sled having a main sled has main sled rails, a main sled first contact plate, a main sled second contact plate, and elastomeric material, the main sled rails disposed on the main sled base plate and substantially parallel to the track, the main sled first contact plate and the main sled second contact plate vertically disposed on opposite ends of the main sled base plate and substantially perpendicular to the main sled rails, the elastomeric material attached to the main sled first contact plate and the main sled second contact plate;
a mini-sled smaller than the main sled such that the mini-sled can travel along the main sled rails, the mini-sled including a mini-sled base plate, a mini-sled first contact plate, a mini-sled second contact plate, the mini-sled first contact plate and the mini-sled second contact plate vertically disposed on opposite ends of the mini-sled base plate and substantially perpendicular to the main sled rails, when actuated the horizontal accelerator fires a pulse that is shaped by the elastomeric material attached to the main sled first contact plate, the pulse causes the main sled to travel along the track, while the mini-sled remains stationary causing the main sled first contact plate to hit the mini-sled first contact plate and simulate acceleration forces on the mini-sled similar to acceleration forces in an actual explosion.

2. The explosive device test fixture of claim 1, wherein the mini-sled further includes sliders, the sliders slidably attached to the mini-sled and the main sled rails.

3. The explosive device test fixture of claim 1, wherein the main sled further includes main sled supports, two main sled supports are attached to the main sled base plate and the first main sled contact plate, while another two main sled supports are attached to the main sled base plate and the second main sled contact plate.

4. The explosive device test fixture of claim 3, wherein the mini-sled further includes mini-sled supports, two mini-sled supports are attached to the mini-sled base plate and the first mini-sled contact plate, while another two mini-sled supports are attached to the mini-sled base plate and the second mini-sled contact plate.
